(19) United States
(12) Patent Application Publication
(10) Pub. No.: US 2013/0277376 A1
(43) Pub. Date: Oct. 24, 2013

(54) PRESSURE VESSEL

(71) Applicants: Adrienne Liebenberg, London (GB); Simone Trautz, Pullach (DE); Carlos Alberto Ferreira Aguiar Pinto, Arouca (PT)

(72) Inventors: Adrienne Liebenberg, London (GB); Simone Trautz, Pullach (DE); Carlos Alberto Ferreira Aguiar Pinto, Arouca (PT)

(21) Appl. No.: 13/822,426

(22) PCT Filed: Sep. 20, 2010
(86) PCT No.: PCT/GB2011/001351

§ 371 Date: Jun. 10, 2013

(30) Foreign Application Priority Data
Sep. 20, 2010 (GB) 1015655.2

(51) Int. Cl. F17C 13/08; B62B 1/26

(52) U.S. Cl. CPC F17C 13/08; B62B 1/26
USPC 220/589

(57) ABSTRACT

A pressure vessel (1) is described comprising an inner fibre-wound pressure vessel (5), a jacket (3), a lid (17) and a wheel base (9). The wheel base (9) comprises a main body (11) having an open end for receiving the base of the jacket (3); a releasable catch (85) operable to attach the main body (11) of the wheel base (9) to a casing (3) mounted on the main body (11) of the wheel base (9) when the base (76) of jacket (3) is inserted into the open end of the wheel base (9); and wheels rotatably (13) attached to the main body (11) of the wheel base (9). When the jacket (3) is mounted to the wheel base (9), the casing (5) and the wheel base (9) are operable to be transferred between locations using the lid (17) and the wheels (13).

The present invention relates to a pressure vessel and relates particularly but not exclusively to a pressure vessel such as a gas cylinder having a separable protective outer casing or jacket which, in some aspects, is tamper proof whilst still being removable without destruction of major portions thereof and is at least partially re-usable without re-cycling of the materials.

A gas cylinder typically comprises a thick-walled steel pressure vessel. Such a gas cylinder is heavy and cumbersome. Lighter weight gas cylinders have been introduced in which the pressure vessel is wound with strengthening fibres, thus enabling its walls to be much thinner. In order to protect the vessel, or ‘liner’ as it is sometimes called, and its winding from damage, the vessel is located in an external plastics jacket.

It is known from U.S. Pat. No. 6,386,384 to provide a protective device for gas cylinders to protect the cylinder itself from damage which is both light weight and does not affect the required heat exchange between the cylinder and the atmosphere. The arrangement includes a top portion and a bottom portion which, in operation, surround the cylinder whilst leaving an upper and a lower surface of the cylinder exposed to the atmosphere such as to allow for the desired heat exchange with the atmosphere. The portions are each made of synthetic material and are interconnected during the assembly process by a standard functional clipping device. The clippings are integral with the upper and lower portions and must be broken in order for the casing to be removed, to allow visual inspection of gas cylinder itself. The two portions are then broken and must be sent for recycling before the material can be used again.

U.S. Pat. No. 7,287,663 also provides a protective device for gas cylinders in which a gas cylinder is surrounded by a metal outer casing comprising an upper and a lower portion. The upper portion surrounds all but an outlet area whilst the lower portion completely surrounds and encases the lower portion of the cylinder. An overlap between the upper and outer portions is accommodated by a dislocation of the upper portion such that the lower portion fits therein such as to present an edge of the upper portion which may be secured to the lower portion by means of a circumferentially extending weld. The arrangement whilst being very secure does not lend itself to easy removal of the jacket for the purpose of inspecting the inner cylinder and requires the addition of a complex collar portion surrounding the outlet area of the gas cylinder and being formed of metal is both heavy and prone to corrosion. The additional weight is a particular disadvantage when employed in combination with light weight composite pressure vessels such as domestic or medical grade gas bottles. The use of welds whilst making the arrangement tamper-proof may prevent the major components being re-used after separation as the removal of the weld will inevitably also damage the protective casing which is clearly very undesirable.

It will be appreciated from the above that there exists a need for a protective casing or jacket for gas cylinders and the like which is both light weight, robust, tamper-proof but removable to allow inspection and maintenance of an encased cylinder and which does not require re-cycling or re-finishing of major components before they can be re-used.

According to the present invention there is provided a pressure vessel comprising an outer protective jacket having an open end and a closed end within which is contained a fibre wound inner pressure vessel receiving a valve assembly enabling the contents of the inner pressure vessel to be controllably discharged, and a wheel base, wherein the wheel base comprises a main body having an open end for receiving the base of the jacket, a releasable catch operable to attach the main body of the wheel base to the jacket when the base of the jacket is inserted into the open end of the wheel base; and wheels rotatably attached to the main body of the wheel base wherein when the jacket is mounted to the main body of the wheel base, the jacket and the wheel base are operable to be transferred between locations using the wheels.

In some embodiments the wheels may be rotatably mounted on an axle and a slot is provided in the main body of the wheel base operable to receive said axle. A clip may be provided within the slot to retain the axle within the slot. Where the open end of the main body is substantially circular the slot provided in the main body may be offset from the centre of the circle defined by the open end of the main body.

The releasable catch may comprise a claw catch or similar operable to engage with a ridge provided on the exterior of the jacket. In some embodiments the releasable catch may comprise a pair of catches provided on opposite sides of the wheel base.

The open end of the main body of the wheel base may be complementary in shape to the exterior of the base of the jacket, the shape of the base of the jacket being such that the jacket may only be mounted to the wheel base in a number of set orientations. A lid may be provided at the end of the jacket remote from the base.

An embodiment of the present invention with now be described with reference to the accompanying drawings in which:

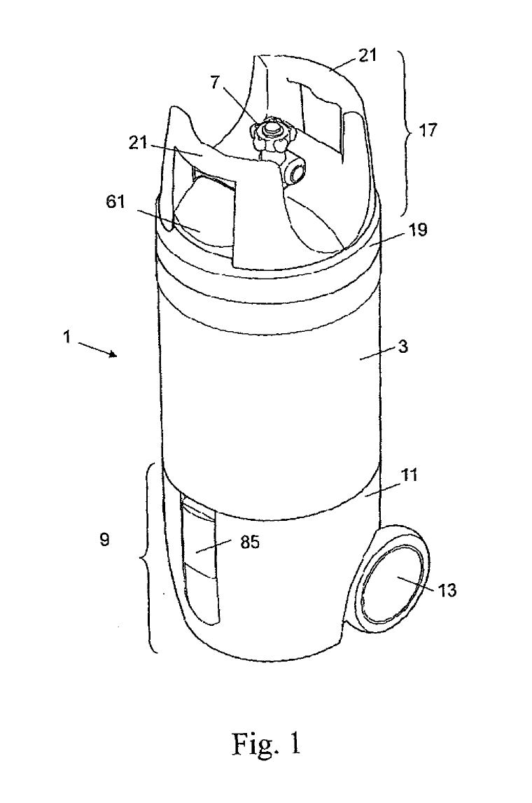

FIG. 1 is a schematic perspective view of a pressure vessel with a separable protective outer jacket in accordance with an embodiment of the present invention;

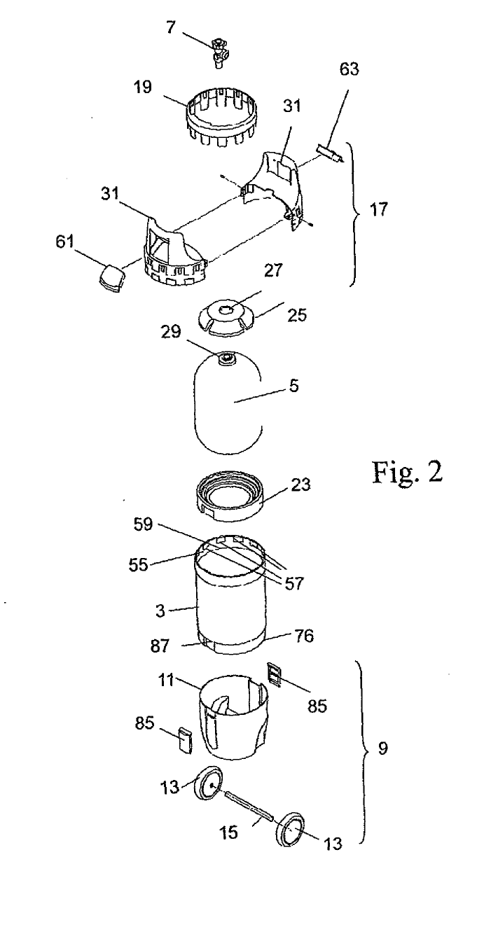

FIG. 2 is an exploded view of the pressure vessel of FIG. 1;

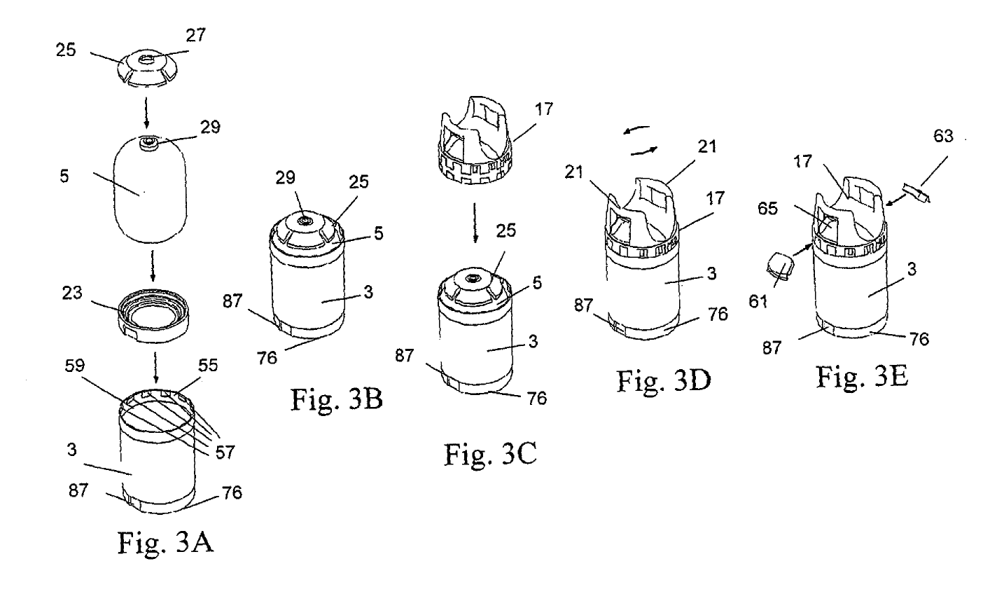

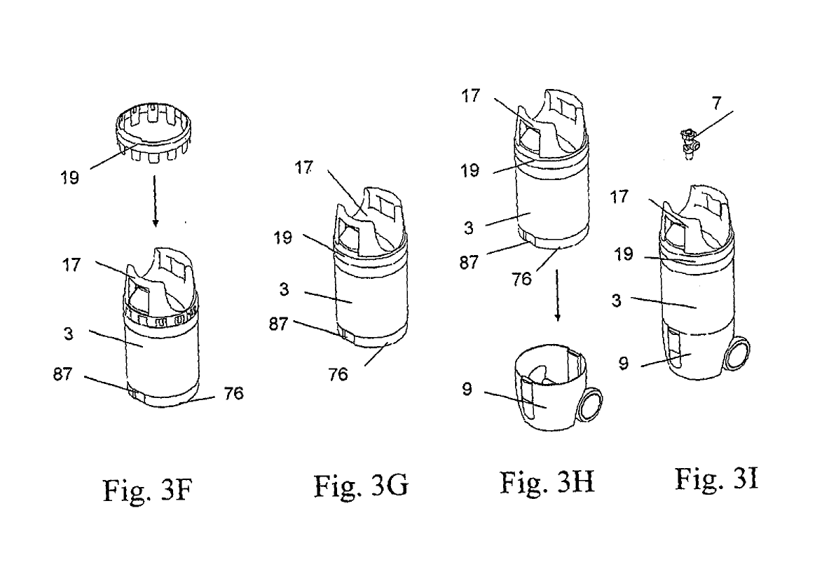

FIGS. 3A-3I are illustrations of the assembly process for assembling the pressure vessel of FIG. 1;

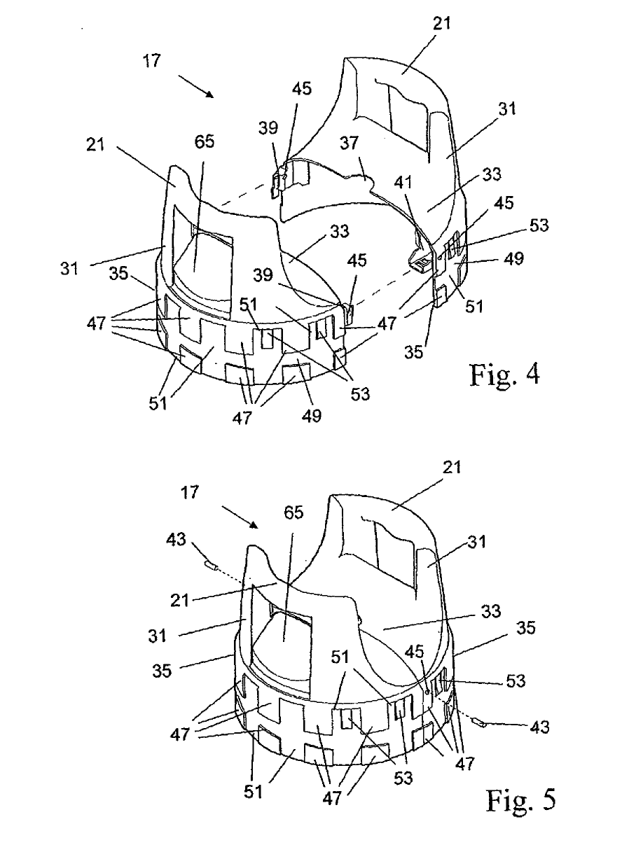

FIGS. 4 and 5 are schematic perspective views illustrating the construction of the lid of the pressure vessel of FIG. 1;

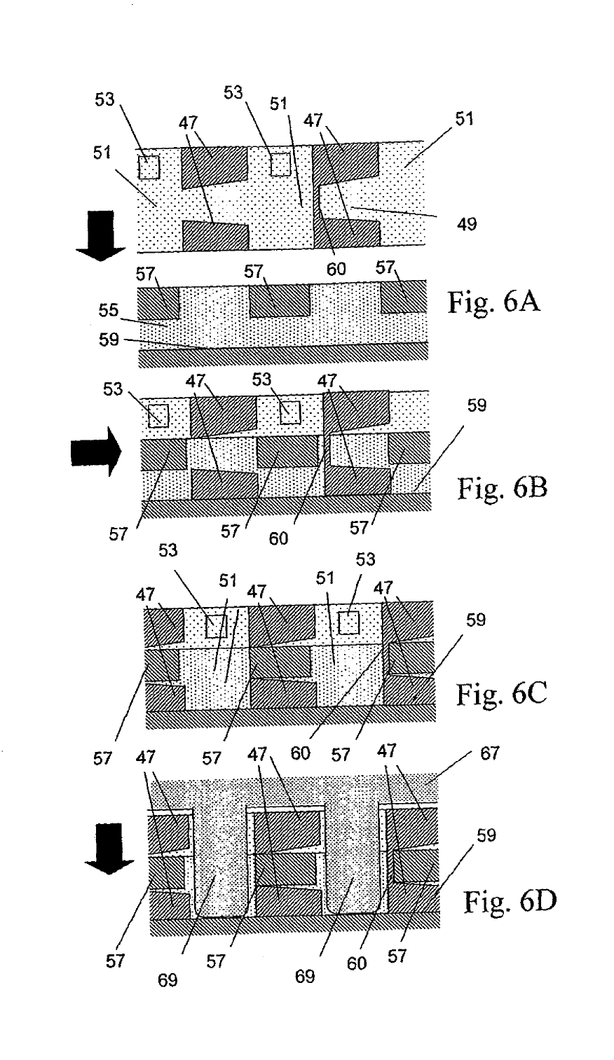

FIGS. 6A-6D are schematic illustrations for explaining the interaction of portions of a lid, outer jacket and a retaining ring of the pressure vessel of FIG. 1;

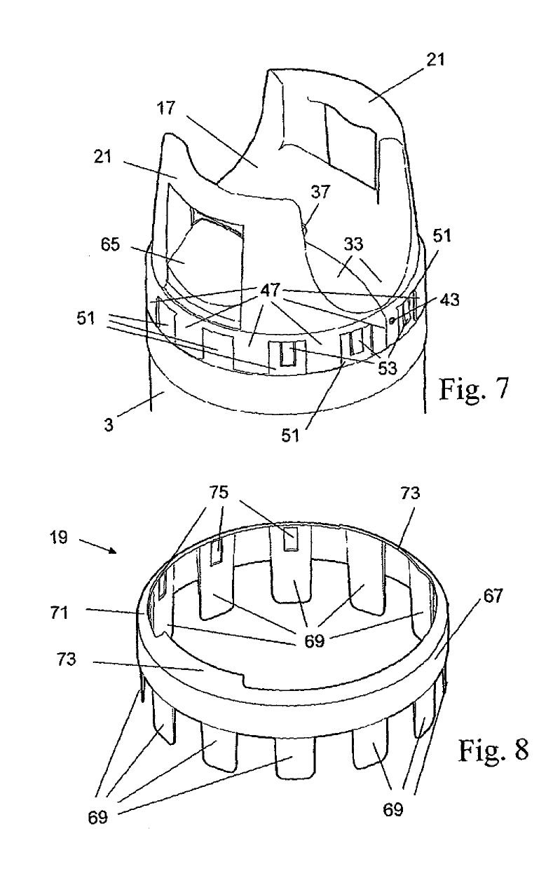

FIG. 7 is a schematic perspective view of the lid of FIGS. 4 and 5 inserted into the outer jacket of a pressure vessel;

FIG. 8 is a schematic perspective view of a retaining ring for use with the pressure vessel of FIG. 1;

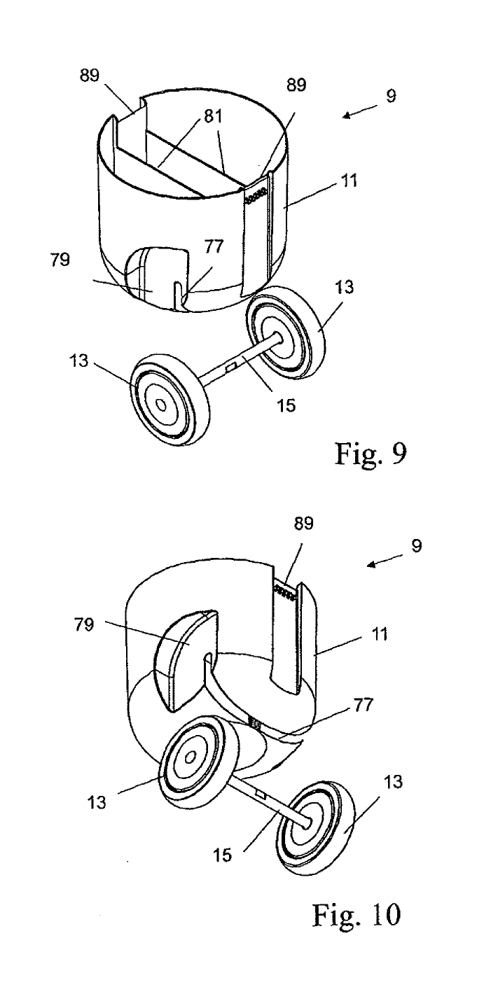

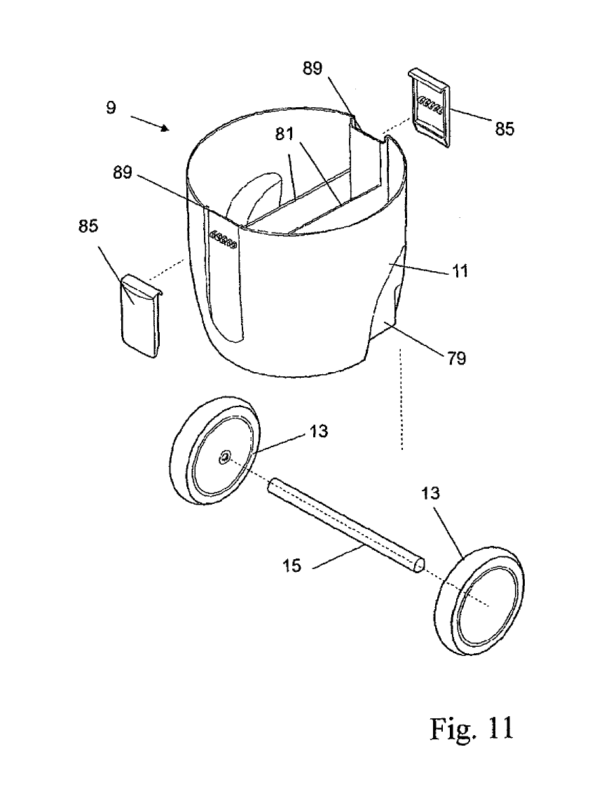

FIGS. 9-11 are exploded views of the wheel base of the pressure vessel of FIG. 1; and

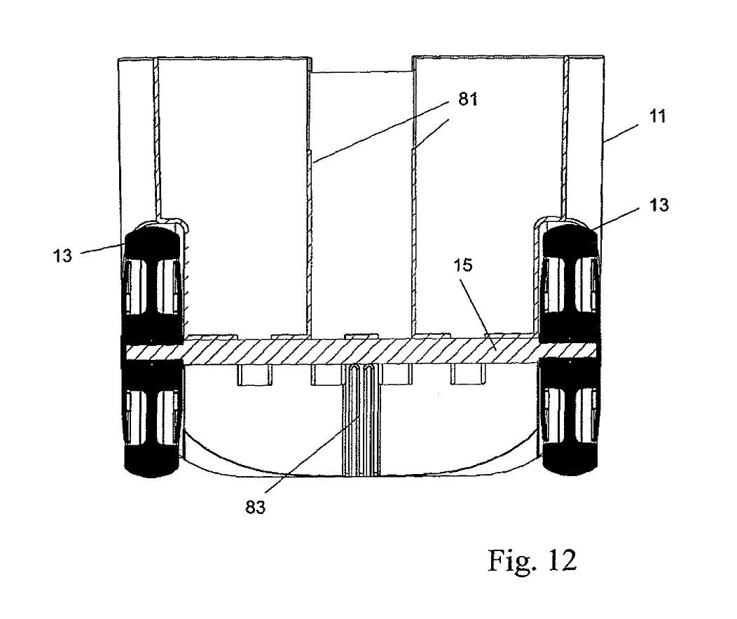

FIG. 12 is a cross sectional view of the wheel base of the pressure vessel of FIG. 1.

FIGS. 1 and 2 are a schematic perspective view and an exploded view of a pressure vessel with a separable protective outer casing in accordance with an embodiment of the present invention.

The pressure vessel 1 comprises a cylindrical outer protective jacket 3 having an open end and a closed end within which is contained a fibre wound inner pressure vessel (or ‘liner’) 5 (not visible in FIG. 1 but visible in FIG. 2). The inner pressure vessel 5 receives a valve assembly 7 enabling the contents of the inner pressure vessel 5 to be controllably discharged.

The protective jacket 3 is mounted on a wheel base 9 which comprises a main body 11 and a pair of wheels 13 attached to an axle 15. A lid 17 which in this embodiment comprises a handle assembly, is attached to the end of the protective jacket 3 remote from the wheel base 9.

When fixed to the protective jacket 3 and the protective jacket 3 is mounted on the wheel base 9, the handle assembly on the lid 17 provides a pair of handles 21 which enables the entire pressure vessel 1 moved from location to location by being tipped and then pulled to a new position using the handles 21 while the wheels 13 on the wheel base 9 rotate about the axle 15. Additionally, the handles 21 protrude above the valve assembly 7 thereby protecting the valve assembly 7 from being knocked and damaged.

As will be described in detail the lid 17 is attached to the protective jacket 3 using a retaining ring 19 which prevents the lid 17 from being removed accidentally but permits the lid 17 to be dismantled when the contents of the inner pressure vessel 5 has been exhausted enabling the inner pressure vessel 5 to be removed from the protective jacket 3 and replaced or refilled.

The assembly of the pressure vessel 1 of FIG. 1 will now be described in greater detail.

Initially as is shown in FIG. 3A a base 23 is inserted into the cavity defined by the walls of the protective jacket 3. This base 23 is a disc of material with a circumference which is slightly smaller than that of the protective jacket 3. One side of the base 23 is substantially flat whereas the opposite surface is indented in a complementary manner to the exterior of the inner pressure vessel 5. When inserted into the protective jacket 3, the flat surface of the base 23 is placed adjacent the enclosed end of the protective jacket 3. In this position the base 23 acts as a protective cushion at the bottom of the protective jacket 3 23 for absorb energy in case the pressure vessel 1 is dropped.

Once the base 23 has been inserted into the interior of the protective jacket 3, the pressure vessel 5 is then inserted into the protective jacket 3. In this embodiment the circumference of the pressure vessel 5 is slightly smaller than the interior circumference of the protective jacket 3. When the inner pressure vessel 5 is inserted into the protective jacket 3 the walls of the protective jacket 3 hold the inner pressure vessel 5 in a fixed orientation with the end of the inner pressure vessel 5 resting upon the indented surface of the base 23.

Once the inner pressure vessel 5 has been inserted into the protective jacket 3, a spacer 25 is placed on the surface of the inner pressure vessel 3 at the open end of the jacket 3. This spacer 25 comprises a disc of protective material similar to that of the base 23. In a similar way to the base 23, the spacer 25 acts to protect inner pressure vessel 5 should the lid 17 be forced against the inner pressure vessel 3. A hole 27 is provided in the centre of the spacer 25 through which a portion 29 of the inner pressure vessel 5 for attachment to the valve assembly 7 protrudes.

FIG. 3B illustrates the protective jacket 3, the inner pressure vessel 5 and the spacer 25 after the inner pressure vessel 5 has been placed within the protective jacket 3, and the spacer 25 has been place on top of the inner pressure vessel 5.

Having inserted the inner pressure vessel 5 into the protective jacket 3 the lid 17 is then constructed and inserted (FIG. 3C) into the open end of the protective jacket 3.

FIGS. 4 and 5 are schematic perspective views illustrating the construction of the lid 17. In this embodiment the lid 17 comprises two identical handle sections 31 made of moulded plastic. Each of the handle sections 31 comprises an upper surface 33, a handle 21, and a perimeter wall 35.

The upper surface 33 is substantially semi circular in shape with a semi circular notch 37 being provided in the centre of the surface 33. These notches 37 are such that when the two parts of the lid 17 are fixed together, the notches 37 define a hole which provides access to the portion 29 of the inner pressure vessel 5 for attaching the valve assembly 7 to the inner pressure vessel 5.

The handles 21 extend away from the upper surfaces 33 of the handle sections 31 and provide means for gripping the lid 17.

The perimeter walls 35 of the handle sections 31 extend along the curved edges of the handle sections 31 on the opposite side of the upper surface 33 to the handles 21. At either end of the perimeter walls 35 are a male 39 and a female 41 latch portions. When the two handle sections 31 are pushed together this causes the male latch portion 39 on one of the handle sections 31 to enter the female 41 latch portion provided on the other handle section 31 and vice versa. When this is done, this latches the two handle sections 31 together.

The configuration of the two handle sections 31 when latched together is shown in FIG. 5.

For additional security, in this embodiment, once the two handle sections 31 have been latched together, the two handle sections 31 are retained in place by passing pins 43 though holes 45 provided in the male and female latch portions 39,41.

A series of rhombozoidal lugs 47 are provided which protrude from the outer surface of the perimeter walls 35. These lugs 47 are arranged in pairs on the outer surface of the perimeter walls 35 and act to divide the perimeter wall 35 into a central circumferential channel 49 and a series of axial channels 51. The rhombozoidal lugs 47 are shaped so that the width of the circumferential channel 49 varies with the width of the channel being narrowest adjacent one edge of each pair of lugs 47 widening to a greatest extent adjacent the adjacent the opposing edge.

In this embodiment the arrangement of the rhombozoidal lugs 47 is such that when the two handle sections 31 are fixed together twelve axial channels 51 are defined equally spaced around the exterior of the lid 17 with each of the channels 51 having the same dimensions. In each of these axial channels 51 except for the axial channels 51 immediately beneath the handles 21 there is provided a detent 53. The detents 53 are such that they can be depressed so as to lie flat against the surface of the axial channels 51 but in the absence of a depressing force the detents 53 protrude beyond the perimeter wall 35 into the axial channels 51 where they are provided. As will be explained later these detents 53 interact with depressions on the inside of the retaining ring 19 to prevent the retaining ring 19 from being withdrawn by a user without the use of a special tool.

Referring to FIGS. 2 and 3A, at the open end of the protective jacket 3, the width of the wall of the protective jacket 3 is reduced in thickness. This defines a channel 55 which extends around the circumference of the interior of the protective jacket 3 immediately adjacent the open end of the jacket 3. A series of projections 57 are provided which extend into this channel 55. These projections 57 are dimensioned so as to have a width slightly smaller than the width of the axial channels 51 on the exterior of the lid 17 and a height slightly larger than the width of the narrowest parts of the circumferential channel 49 on the lid 17. The projections 57 are arranged around the circumference of the interior of the protective jacket 3 in the same way in which the axial channels 51 are arranged on the exterior of the lid 17. The projections 57 are spaced from the bottom edge 57 of the channel 55 at the open end of the protective jacket 3 by a distance slightly less than the distance between the edge of the circumferential channel 49 on the lid 17 at its narrowest point and the edge of the perimeter wall 35 of the lid 17 remote from the handles 21.

The interaction of the lugs 49 on the lid 17 with the projections 57 extending into the interior of the protective jacket 3 adjacent the open end of the protective jacket 3 will now be described with reference to FIG. 6.

FIG. 6A shows is a schematic illustration of the relative arrangements of the lugs 47 on the lid 17 and the protections 57 within the channel 55 at the open end of the protective jacket 3 when the projections 57 on the interior of the protective jacket 3 are aligned with the axial channels 51 on the exterior of the lid 17.

As can be seen in FIG. 6A because the protections 57 on the interior of the protective jacket 3 are arranged in a complementary fashion to the axial channels 51 and have widths which are smaller than the dimensions of the axial channels 51, the lid 17 can be inserted into the open end of the protective jacket 3. This is because when the projections 57 are aligned with the axial channels 51, the dimensions of the projections 57 are such that they can pass along the axial channels 51 without being fouled by the lugs 47 on the lid 17. This can continue until the edge of the perimeter wall 35 of the lid 17 reaches the bottom edge 57 of the channel 55 at the open end of the protective jacket 3.

FIG. 6B illustrates the relative positioning of the lugs 47 and projections 57 when the end of the lid 17 has been inserted into the channel 55 until the edge of the perimeter wall 35 of the lid 17 reaches the bottom edge 57 of the channel 55 at the open end of the protective jacket 3.

At this point the projections 57 on the interior of the protective jacket 3 lie at the intersections of the circumferential channel 49 with the axial channels 51 on the exterior of the perimeter wall 35 of the lid 17.

The external appearance of the lid 17 and the top of the protective jacket 3 once the end of the lid 17 has been inserted into the open end of the protective jacket 3 is illustrated in FIG. 7.

When in this position the lid 17 can be removed from the open end of the protective jacket 3 by pulling the lid 17 away from the jacket 3 because the projections 57 on the interior of protective jacket 3 lie within the axial channels 51 on the exterior of the lid 17.

However, the lid 17 can be fixed in position by rotating (FIG. 3D) the lid 17 within the protective jacket 3 about the protective jacket's axis of symmetry. This is because when the projections 57 lie at the intersection of the axial 51 and circumferential channels 49 on the exterior of the lid 17, the projections 57 can pass along the wider sections of the circumferential channel 49 without being fouled by the lugs 47 on the exterior of the lid 17. In this embodiment, where the projections are rhombozoidal in shape, once inserted into the open end of the protective jacket 3 the lid can only be rotated in a single direction (in this embodiment anti clockwise) as the protrusions 57 are unable to pass through the narrowest potions of the circumferential channel 49.

Additionally, in this embodiment two pairs of lugs 47 are connected by a rib 60 which extends across the circumferential channel 49. These ribs 60 are provided on opposite sides of the perimeter wall 35 of the lid 17 spaced 180° apart and connect the lugs 49 either side of the channel 49 where the channel 49 is narrowest. These ribs 60 act as a further stop preventing the lid 17 from being rotated other than in a single direction when in the position of FIG. 6B.

If the lid is rotated about the axis of symmetry of the protective jacket 3, this causes the relative positions of the lugs 47 and projections 57 to become arranged as in FIG. 6C.

In the position shown in FIG. 6C further rotation is not possible as the projections 57 on the interior of the casing are prevented from turning further as they cannot pass though the narrowest portions of the circumferential channel 49 and come to rest against the ribs 60 extending across the circumferential channel 49. When in the configuration in FIG. 6C it is also not possible to remove the lid 17 from the protective jacket 3 by pulling the lid away from the protective jacket 3 as the projections 57 are aligned with the lugs 47 on the lid 47 which prevents the lid 17 from exiting the protective jacket 3.

Returning to FIG. 3, having rotated (FIG. 3D) the lid 17, covers 61 or electronic monitoring equipment 63 are then (FIG. 3E) fixed within apertures 65 provided in the upper surface 33 of the lid 17 adjacent the handles 21. The provision of covers 61 or electronic monitoring equipment 63 provides a user with a choice as to whether monitoring equipment 61 is provided on the pressure vessel 1. This choice will depend upon the users requirements for monitoring the contents of the inner pressure vessel 5.

Having attached the required covers 61 and/or monitoring equipment 63, the configuration of the pressure vessel 1 is then fixed by placing (FIG. 3F) a retaining ring 19 over the lid 17.

FIG. 8 is a schematic perspective view of a retaining ring 19 for use with the pressure vessel 1. The retaining ring 19 comprises a circular band 67, from which extend twelve tabs 69. These tabs 69 are equally spaced around the circumference of the band 67 and are dimensioned so as to fit within the twelve axial channels 51 on the exterior of the lid 17. A sloped flange 71 is provided on the opposite edge of the circular band 67 to the edge from which the tabs 69 extend. This flange 71 slopes inwardly from the walls of the circular band 67 with two portions 73 of the flange 71 having a greater extent beyond the circular band 67 than the rest of the flange 71.

The configuration of the retaining ring 19 is such that it can fit over the lid 17 with the portions 73 of the flange 71 of greater extent lying inside the arches formed by the handles 21. In this position the flange extensions 73 extend over the edge of any cover 61 or monitoring equipment 63 inserted in the apertures 65 provided in the lid 17. Thus in this way the flange extension 73 acts to prevent the covers 61 or monitoring equipment 63 from being removed.

When the retaining ring 19 is placed over the lid 17, as is illustrated in FIG. 6D the tabs 69 extending from the circular band 67 pass through the axial channels 51 on the exterior of the lid 17. This then causes the projections 57 on the interior of the protective jacket 3 and the lugs 47 on the exterior of the lid 17 to be trapped in position as the tabs 69 prevent the lid 17 from being rotated to move the lid 17 back to the position illustrated in FIG. 6B from which the lid 17 can be removed from the protective jacket 3.

In this embodiment in order to prevent a user removing the retaining ring 19 once it has been inserted, recesses 75 are provided on the interior of the circular band 67 above each of the tabs 69 except the tabs 69 extending from the portions of the circular band 67 where the flange extension are provided 73. As the tabs 69 pass over the detents 51, the detents 51 on the exterior of the lid 17 are caused to be depressed. When the tabs 69 of the retaining ring 19 are fully inserted into the axial channels 51 on the exterior of the lid 17, the recesses 75 are positioned opposite the detents 53 on the exterior of the lid 19. This releases the detents 53 which enter the recesses 75 locking the retaining ring 19 in place. With the retaining ring 19 locked in place, as it is not possible to remove the retaining ring 19 it is not possible to rotate the lid 17 relative to the protective jacket 3 and hence the lid 17 cannot be removed from the protective jacket 3.

Should removal of the lid 17 be desired for example in order to refill or replace the inner pressure vessel 5, a tool can be inserted into the gap between the retaining ring 19 and the exterior of the lid 17 where the detents 53 are present. Inserting a tool into the gap between the retaining ring 19 and the exterior of the lid 17 would then depress the detents 53 removing the detents 53 from the recesses 75 in the retaining ring 19. This would then permit the retaining ring 19 to be removed.

In order for the retaining ring 17 to be removed in this embodiment all the detents 53 would need to be simultaneously depressed. This can be achieved by depressing the detents 53 using a pair of curved tools corresponding to the curve of the exterior of the lid 17 adjacent the detents 53. Requiring that removal is dependent upon the simultaneous depression of multiple detents 53 acts to ensure that removal can only be effected using a suitable tool and hence accidental removal by a user in the absence of such a tool is prevented.

The configuration of the pressure vessel 1 with the retaining ring 19 attached is illustrated in FIG. 3G. As is illustrated, in this embodiment the exterior circumference of the band of the retaining ring 19 is the same as the exterior circumference of the protective jacket 3 are such that the retaining ring 19 forms a flush fit with the protective jacket 3.

Having attached the retaining ring 19 to the pressure vessel 1, the pressure vessel 1 is then (FIG. 3H) mounted onto the wheel base 9.

FIGS. 9-11 are exploded view of the wheel base 9. As noted previously the wheel base 9 comprises a main body 11 and a pair of wheels 13 attached to an axle 15. The main body 11 is substantially cylindrical with an open end and a closed end. In this embodiment, the dimensions of the main body 11 are such to have the same outer circumference as the protective jacket 3 and an inner circumference slightly larger than the circumference of a narrowed portion 76 of the protective jacket 3 which runs as a band about the circumference of the jacket 3 adjacent the closed end of the protective jacket 3.

A slot 77 for receiving the axle 15 is provided at the closed end of the main body 11 with the slot 77 being offset from the centre of the main body 11. The side walls of the main body 11 are indented adjacent the slot 77 so as to define two wheel arches 79. A pair of strengthening ribs 81 are provided with the interior of the cavity defined by the walls of the main body 11. These ribs 81 extend across the interior the main body 11 and to a height slightly below the top edge of the walls of the main body 11 act to increase the rigidity of the main body 11.

FIG. 12 is a cross sectional view of the wheel base 9 through the slot 77. In this embodiment a spring clip 83 is provided on one of the walls defining the slot 77. When assembling the wheel base 9 the axle 15 is pushed up the slot 77 passing the clip 83. As the axle 15 passes the clip 83, the spring clip 83 initially depressed and then released once the axle 15 has passed the clip 83. When released the spring clip 83 protrudes into the slot and thereby acts to retain the axle 15 in place within the slot 77.

A pair of claw latches 85 are provided on opposite sides of the main body 11 of the wheel base 9. The claw latches 85 are arranged to engage with a ridge near the base of the protective jacket 3 just above the narrowed portion 76 of the protective jacket 3 when the enclosed end of the protective jacket 3 is inserted into the open end of the main body 11 of the wheel base 9.

In this embodiment to assist with the positioning of the protective jacket 3 on the wheel base 9, the a pair of indentations 87 are provide on the exterior of the protective jacket 3 adjacent the closed end of the protective jacket 3 and a corresponding pair of indentations 89 are provided in the walls of the main body 11 of the wheel base 9. When the indentations 87 at the base of the protective jacket 87 are aligned with the indentations 89 in the walls of the main body 11 of the wheel base 9 the narrowed portion 76 of the protective jacket 3 is able to enter into the open end of the wheel base 9 until the base of the protective jacket 3 comes to rest upon the ribs 81 on the interior of the wheel base 9. When mounted on the wheel base 9 in this fashion the ridge on the exterior of the protective jacket 3 is caused to be located in a position immediately above the claw latches 85 and the protective jacket 3 can be secured to the wheel base 9 by engaging the latches 85 to the ridge at the base of the protective jacket 3.

Having mounted the pressure vessel 1 to the wheel base 9 a valve assembly 7 is then (FIG. 3I) attached to the portion 29 of the inner pressure vessel 5 accessible via the hole 27 at the centre of the spacer 25 and the hole formed by the two semi-circular notches 37 at the centre of the lid 17.

The completed pressure vessel 1 can then be transported from place to place by pulling on the handle 21 closest to the axle 15 of the wheel base 9 causing the pressure vessel 1 to rotate about the axle 15 and lift the portion of the wheel base 9 remote from the wheels 13 off the ground. The pressure vessel 1 can then be pulled to a new location whilst as the wheels 15 rotate before being placed upright again as shown in FIG. 1.

Although in the above embodiment the lid 17 has been described as being formed from two separable sections 31, it will be appreciated that in some embodiments the lid 17 could be an integrally formed unit. It will also be appreciated that in other embodiments the specific details of the retaining ring 19, the lugs 47 on the exterior of the lid 17 and the protections 57 on the interior of the protective jacket 3 could be modified.

Thus for example it would be appreciated that whereas in the above described embodiment a lid 17 is described as having twelve axial channels and the retaining ring 19 is described as having twelve tabs 69 in other embodiments greater or lesser numbers of channels 51 and tabs 69 may be provided.

It will also be appreciated that whereas in the above described embodiment the projections 57 are described as being prevented from passing though the narrowest portions of the circumferential channel 49 defined by the lugs 47 on the exterior of the lid 17, with some of the lugs 49 being connected by ribs 60, in other embodiments other means could be provided to limit the possible extent and direction of rotation of a lid 17. Thus for example either a circumferential channel 49 of variable width or one or more ribs 60 alone could be provided on the exterior of the lid 17 to limit the extent the lid 17 could be rotated after being inserted into a protective jacket 3.

In addition it will also be appreciated that whereas in the above embodiment channels 49, 51, have been described as being provided on the exterior of a lid 17 which are arranged to receive projections 57 extending from the interior of a protective jacket 3, in other embodiments these arrangements could be reversed. That is to say a circumferential channel intersected by a number of axial channels could be provided on the interior of a protective jacket 3 where the channels are arranged to receive an arrangement of projections on the exterior of a lid.

Although in the above embodiment the projections 57 on the interior of a protective jacket 3 are described as being spaced from the edge of a channel 55 at the open end of the jacket 3, it will be appreciated that in some embodiments the projections 57 may be provided immediately adjacent the channel walls.

Further although in the above embodiment projections 57 have been described as being provided extending inward into the interior of the cavity defined by the walls of the protective jacket 3, in other embodiments the projections 57 could be provided on the exterior of the jacket 3 with a complementary arrangement of lugs 47 being provided on the interior of the perimeter wall 35 of the lid 17.

1. A pressure vessel comprising an outer protective jacket having an open end and a closed end within which is contained a fibre wound inner pressure vessel receiving a valve assembly enabling the contents of the inner pressure vessel to be controllably discharged, and a wheel base, wherein the wheel base comprises:
a main body having an open end for receiving the base of the jacket;
a releasable catch operable to attach the main body of the wheel base to the jacket when the base of the jacket is inserted into the open end of the wheel base; and
wheels rotatably attached to the main body of the wheel base wherein
when the jacket is mounted to the main body of the wheel base, the jacket and the wheel base are operable to be transferred between locations using the wheels.

2. The pressure vessel in accordance with claim 1 wherein said wheels are rotatably mounted on an axle and a slot is provided in the main body of the wheel base operable to receive said axle.

3. The pressure vessel in accordance with claim 2, wherein a clip is provided within said slot to retain the axle within the slot.

4. The pressure vessel in accordance with claim 2 wherein the open end of the main body is substantially circular wherein the slot provided in the main body is offset from the centre of the circle defined by the open end of the main body.

5. The pressure vessel in accordance with claim 1 wherein said releasable catch comprises a claw catch or similar operable to engage with a ridge provided on the exterior of the jacket.

6. The pressure vessel in accordance with claim 5 where said releasable catch comprises a pair of catches provided on opposite sides of the wheel base.

7. The pressure vessel in accordance with claim 1, wherein the open end of the main body is complementary in shape to the exterior of the base of the jacket, the shape of the base of the jacket being such that the jacket may only be mounted to the wheel base in a number of set orientations.

8. The pressure vessel in accordance with claim 1 further comprising a lid at the end of the casing remote from the base.
